(19) United States
(12) Patent Application Publication
(10) Pub. No.: US 2013/0179084 A1
(43) Pub. Date: Jul. 11, 2013

(54) HAND-HELD TEST METER WITH SIGNAL RECOVERY BLOCK

(71) Applicants: David ELDER, Invemess (GB); Thomas Jetter, Mainz (DE)

(72) Inventors: David ELDER, Invemess (GB); Thomas Jetter, Mainz (DE)

(73) Assignee: Cilag GmbH International, Zug (CH)

(21) Appl. No.: 13/344,932

(22) Filed: Jan. 6, 2012

(51) Int. Cl. G06F 19/00; G06F 15/00

(52) U.S. Cl. 702/19; 702/199

(57) ABSTRACT

A hand-held test meter (“HHTM”) for use with an analytical test strip in the determination of an analyte in a bodily fluid sample includes a housing, an electrical signal receiving block, a signal recovery block and a microcontroller block, all of which are disposed in the housing. The electrical signal receiving block is configured to receive an electrical signal from an analytical test strip inserted in the HHTM that has been distorted into a distorted electrical signal. In addition, the signal recovery block and microcontroller block are configured to recover the electrical signal from the distorted electrical signal by generating a recovered electrical signal based on a predetermined recovered electrical signal frequency, a recovered electrical signal amplitude estimated from the distorted electrical signal, a recovered electrical signal offset estimated from distorted electrical signal and a recovered electrical signal phase determined using a least sum squares calculation.

### BACKGROUND OF THE INVENTION

1. Field of the Invention

The present invention relates, in general, to medical devices and, in particular, to test meters and related methods.

2. Description of Related Art

The determination (e.g., detection and/or concentration measurement) of an analyte in a fluid sample is of particular interest in the medical field. For example, it can be desirable to determine glucose, ketone bodies, cholesterol, lipoproteins, triglycerides, acetaminophen and/or HbA1c concentrations in a sample of a bodily fluid such as urine, blood, plasma or interstitial fluid. Such determinations can be achieved using a hand-held test meter in combination with analytical test strips (e.g., electrochemical-based analytical test strips).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified top view of a hand-held test meter according to an embodiment of the present invention;

FIG. 2 is a simplified block diagram of various electrical circuit blocks of the hand-held test meter of FIG. 1;

FIG. 3 is a simplified graphical depiction of a distorted electrical signal received by a hand-held test meter according to embodiments of the present invention;

FIG. 4 is a simplified graphical depiction of the distorted electrical signal of FIG. 3 and an initial generated signal of a hand-held test meter according to embodiments of the present invention;

FIG. 5 is a simplified graphical depiction of the difference between the distorted electrical signal and the initial generated signal of FIG. 4;

FIG. 6 is a simplified graphical depiction of a least squares calculation employed in various embodiments of the present invention;

FIG. 7 is a simplified graphical depiction of the distorted electrical signal of FIG. 3 and the recovered signal of a hand-held test meter according to embodiments of the present invention; and

FIG. 8 is a flow diagram depicting stages in a method for recovering a signal employed in a hand-held test meter according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, hand-held test meters for use with an analytical test strip (such as an electrochemical-based analytical test strip) in the determination of an analyte (e.g., glucose) in a bodily fluid sample include a housing, an electrical signal receiving block disposed in the housing, a signal recovery block disposed in the housing, and a microcontroller block disposed in the housing. In addition, the electrical signal receiving block is configured to receive an electrical signal from an analytical test strip inserted in the hand-held test meter that has been distorted into a distorted electrical signal. Furthermore, the signal recovery block and microcontroller block are configured to recover the electrical signal from the distorted electrical signal by generating a recovered electrical signal based on (i) a predetermined recovered electrical signal frequency, (ii) a recovered electrical signal amplitude estimated from the distorted signal, (iii) a recovered electrical signal offset estimated from the distorted electrical signal and (iv) a recovered electrical signal phase determined using a least sum squares calculation.

Hand-held test meters according to embodiments of the present invention are beneficial in that, for example, the recovered electrical signal can be employed during use of the hand-held test meter, thus increasing accuracy and reliability of such use. In addition, the hand-held test meters according to embodiments of the present invention generate the recovered electrical signal in a relatively short time period and can employ low power components (e.g., low power microcontroller blocks).

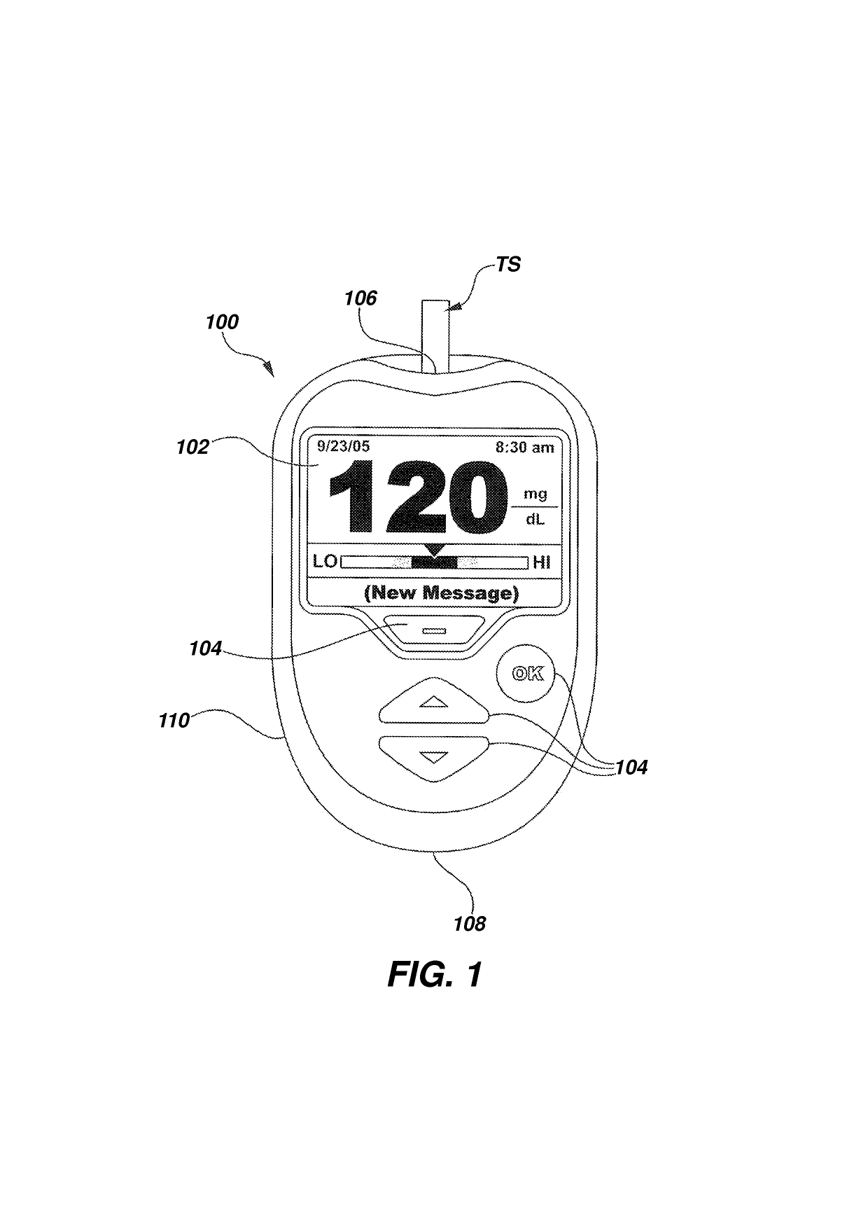

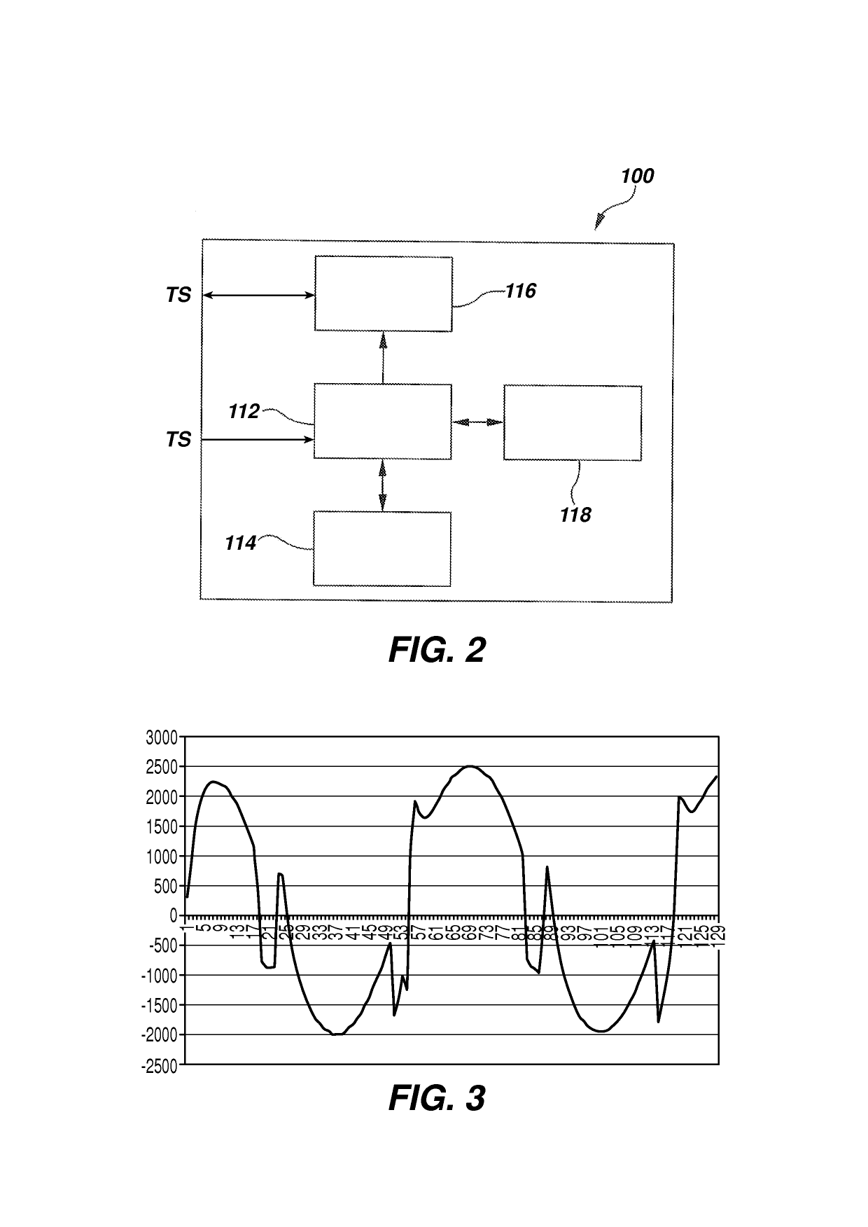

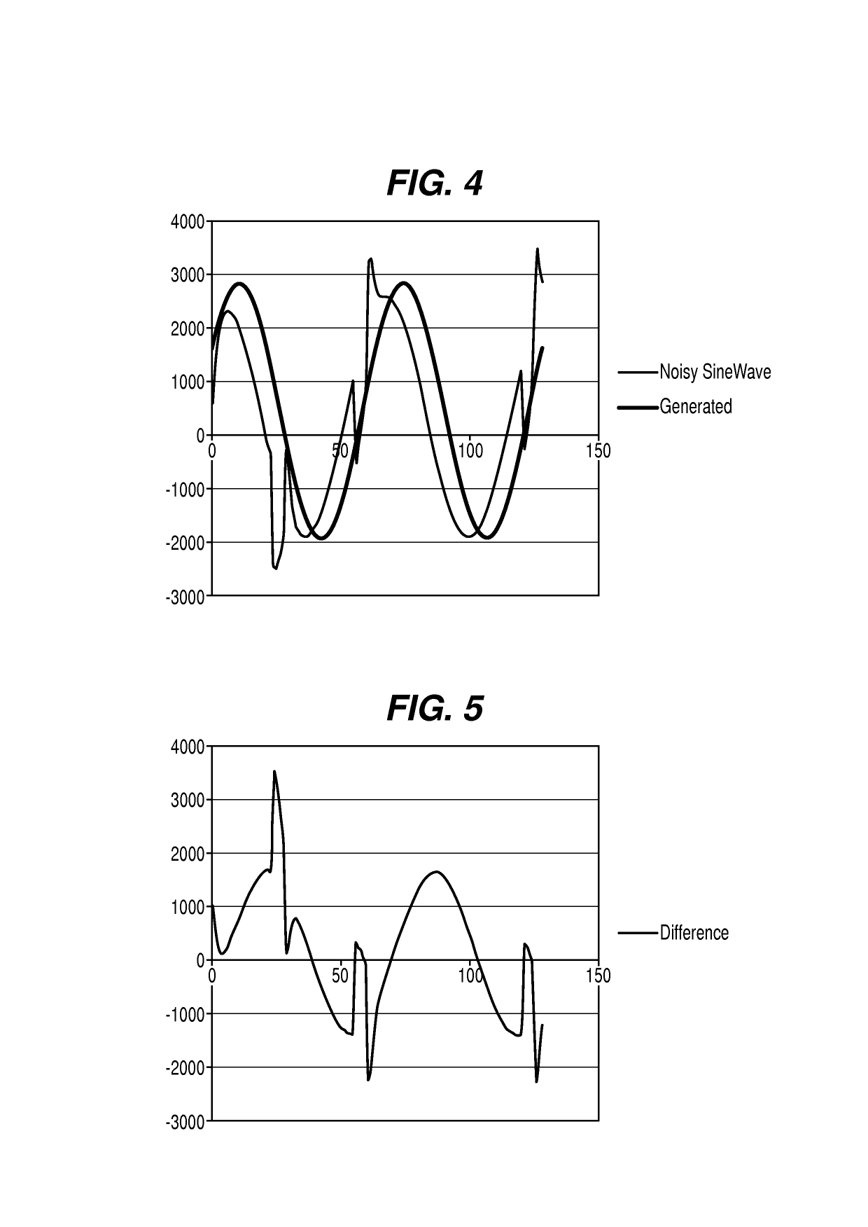

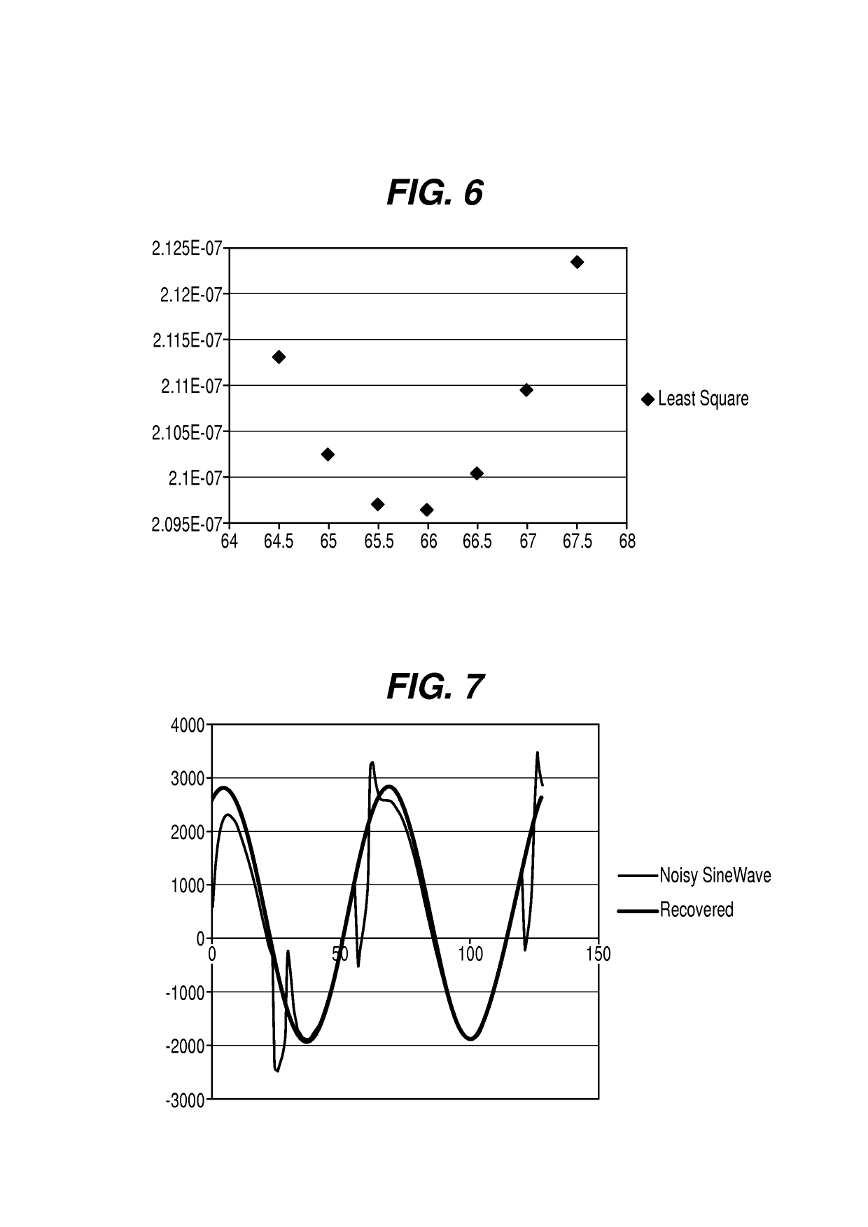

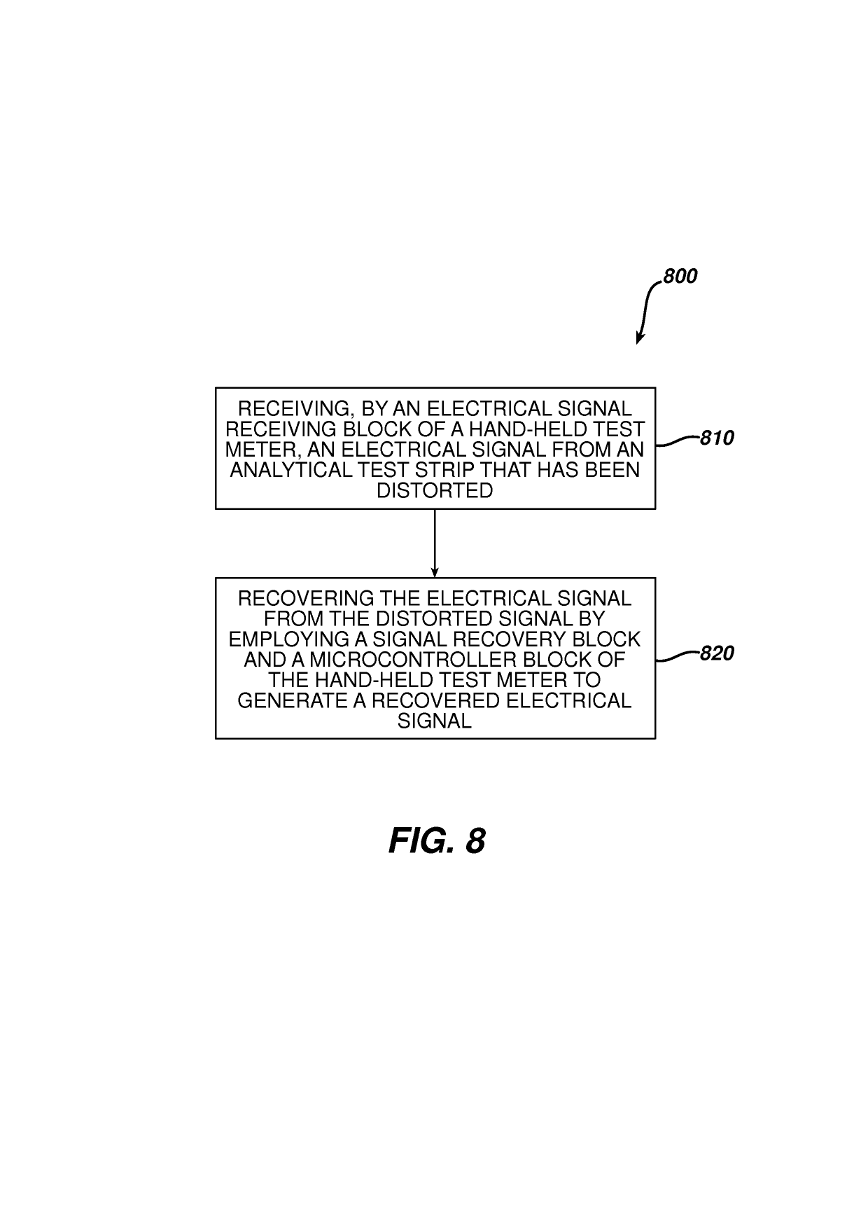

FIG. 1 is a simplified depiction of a hand-held test meter 100 according to an embodiment of the present invention and an analytical test strip (TS) inserted therein. FIG. 2 is a simplified block diagram of various blocks of hand-held test meter 100. FIG. 3 is a simplified graphical depiction of a distorted electrical signal received by hand-held test meter 100. FIG. 4 is a simplified graphical depiction of the distorted electrical signal of FIG. 3 and an initial generated signal of hand-held test meter 100. FIG. 5 is a simplified graphical depiction of the difference between the distorted electrical signal and the initial generated signal of FIG. 4. FIG. 6 is a simplified graphical depiction of a least squares calculation conducted by hand-held test meter 100. FIG. 7 is a simplified graphical depiction of the distorted electrical signal of FIG. 3 and a recovered signal of hand-held test meter 100. The x-axis of FIGS. 3, 4, 5 and 7 represents time with each unit being approximately 143 microseconds. The y-axis of FIGS. 3, 4 and 5 is a voltage representative of current measured in nano-amps. In FIG. 6, the x-axis is degrees and the y-axis is the y-axis is a least squares sum.

Referring to FIGS. 1 through 7, hand-held test meter 100 includes a display 102, a plurality of user interface buttons 104, a strip port connector 106, a USB interface 108, and a housing 110 (see FIG. 1). Referring to FIG. 2 in particular, hand-held test meter 100 also includes an electrical signal receiver block 112, a signal recovery block 114, a microcontroller block 116, a memory block 118 and other electronic components (not shown) for applying a test voltage to analytical test strip (labeled TS in FIG. 1), and also for measuring an electrochemical response (e.g., plurality of test current values) and determining an analyte based on the electrochemical response. To simplify the current descriptions, the figures do not depict all such electronic circuitry.

Display 102 can be, for example, a liquid crystal display or a bi-stable display configured to show a screen image. An example of a screen image may include a glucose concentration, a date and time, an error message, and a user interface for instructing an end user how to perform a test.

Strip port connector 106 is configured to operatively interface with an analytical test strip TS, such as an electrochemical-based analytical test strip configured for the determination of glucose in a whole blood sample. Therefore, the analytical test strip is configured for operative insertion into strip port connector 106 and to operatively interface with electrical signal receiver block 112 and microcontroller block 116 via, for example, suitable electrical contacts.

USB Interface 108 can be any suitable interface known to one skilled in the art. USB Interface 108 is essentially a passive component that is configured to power and provide a data line to hand-held test meter 100.

Once an analytical test strip is interfaced with hand-held test meter 100, or prior thereto, a bodily fluid sample (e.g., a whole blood sample) is introduced into a sample chamber of the analytical test strip. The analytical test strip can include enzymatic reagents that selectively and quantitatively transform an analyte into another predetermined chemical form. For example, the analytical test strip can include an enzymatic reagent with ferricyanide and glucose oxidase so that glucose can be physically transformed into an oxidized form.

Memory block 118 of hand-held test meter 100 includes a suitable analyte determination algorithm and is configured to store a received distorted signal. Moreover, memory block 118 can also be configured, along with microcontroller block 116 to determine an analyte based on the electrochemical response of analytical test strip.

Microcontroller block 116 is disposed within housing 110 and can include any suitable microcontroller and/or micro-processer known to those of skill in the art. One such suitable microcontroller is a microcontroller commercially available from Texas Instruments, Dallas, Tex. USA and part number MSP430F5636. This microcontroller can function as a signal generation block as described further below. MSP430F5636 also has Analog-to-Digital (ND) processing capabilities suitable for processing voltages (e.g., voltages received from a transimpedance amplifier of electrical signal receiving block 112).

Electrical signal receiving block 112 is configured to receive an electrical signal (such as a sine wave signal) from an analytical test strip inserted in the hand-held test meter that has been distorted into a distorted electrical signal. In other words, the electrical signal that is generated at the analytical test strip can be distorted by an interfering electromagnetic field into a distorted electrical signal and it is that distorted electrical signal that is received by electrical signal receiving block 112. Such a distorted electrical signal is depicted in FIGS. 3, 4 and 7 and is also referred to as a “Noisy SineWave.” Electrical receiving block 112 can be, for example, a transimpedance amplifier configured to convert a current to a voltage. After receipt, the distorted electrical signal is stored in memory block 118 for further use during signal recovery. It should be noted that in the examples depicted in FIGS. 3 through 7, the distorted electrical signal consists of 64 discrete measurements per cycle with the FIGs. depicting a continuous line that result from joining the discrete measurements.

A non-limiting example of a sine wave electrical signal is an alternating current (ac) signal generated during measurement of a capacitance of the analytical test strip in response to an applied ac excitation voltage. Such an applied ac excitation voltage can be created by, for example, microcontroller block 116 of hand-held test meter 110.

Signal recovery block 114 and microcontroller block 116 are configured to recover the electrical signal from the distorted electrical signal by generating a recovered electrical signal based on a predetermined recovered electrical signal frequency, a recovered electrical signal amplitude estimated from the distorted signal, a mean offset of the distorted electrical signal and a recovered electrical signal phase determined using a least squares calculation. An exemplary technique for generating the recovered electrical signal is described below.

To generate a recovered electrical signal, a predetermined electrical signal frequency is assigned as the fixed frequency of the recovered electrical signal. The predetermined electrical signal can be, for example, the frequency of an alternating current (AC) excitation voltage that was applied to the analytical test strip to create the electrical signal which was subsequently distorted. A typical but non-limiting example would be a frequency of 109 Hz.

The recovered electrical signal amplitude is estimated as a root-mean-square from the distorted electrical signal. A representative equation for calculating the root-mean-square of a voltage signal (i.e., V(rms)) from a distorted electrical signal consisting of 64 discrete measurements is as follows:

$$V ( rms ) = \sqrt{{\sum }_{x = 0}^{64} {( Vsample [ x ] )}^{2}}$$

where:
x=represents an individual measurement; and
Vsample[x]=the distorted electrical signal voltage for measurement x.
   Once apprised of the present disclosure, one skilled in the art will recognize that embodiments of the present invention can be readily applied to distorted signals originating as currents and converted to representative voltages (such as those in FIGS. 3, 4 and 7) or any other suitable electrical signal characteristic by modifying the equations herein to replace the voltage terms with the appropriate alternative terms. For example, for current signals, V(rms) and Vsample[x] would be replaced with I(rms) and Isample[x].

The offset is estimated as an average of all discrete measurements along the distorted electrical signal. For example, if the distorted electrical signal was received as a sequence of 64 discrete measurements, then those 64 measurements points are averaged to estimate the offset.

To estimate the recovered electrical signal phase, an ideal sine wave is generated based on the predetermined electrical signal frequency, the estimated recovered signal amplitude, the estimated recovered signal offset and an arbitrary phase (such as 30 degrees). Such an ideal sine wave (also referred to as an initial generated signal) is depicted in FIG. 4 and labeled “Generated.” The arbitrary phase can, if desired, be predetermined as the lowest possible phase for a given hand-held test meter and analytical strip configuration.

The difference between the ideal sine wave and the distorted electrical signal is then calculated. FIG. 5 depicts such a difference curve. Each point on the difference curve is then squared and summed to provide an overall sum of squares value. A representative equation for calculating the overall sum of squares value for an ideal voltage signal (i.e., V) from a distorted electrical signal consisting of 64 discrete measurements is as follows:

$$V = {\sum }_{x = 0}^{64} {( Vdistorted [ x ] - Videal [ x ] )}^{2}$$

where:

Vdistorted[x]=the voltage of distorted electrical signal measurement x;

and

Videal[x]=the voltage for the ideal sine wave at measurement point x.

For any given arbitrary phase and associated ideal sine wave, a “sum of squares” figure (value) can be obtained. The closer the phase of the ideal sine wave is to the original electrical signal prior to distortion, the smaller the “sum of squares” value will be. Therefore, the best estimation of the phase of the recovered electrical signal occurs when the “sum of squares” value reaches a minimum, hence the Least Sum Square (LSS) nomenclature. FIG. 6 (wherein the y-axis is LSS value and the X-axis is phase) depicts a minimum at a phase of 66 degrees.

Finally, the recovered electrical signal is generated based on the best estimated phase determined using the LSS method, the predetermined frequency, the estimated amplitude and the estimated offset. Such a recovered electrical signal is depicted in FIG. 7. A signal can typically be recovered using the techniques included in embodiments according to the present invention based on, for example, a maximum of 2,500 additions, 1250 multiplications, and 1250 sinewave lookups. Assuming a microcontroller block running at 10 MHz, the total computation time is approximately 70 ms. However, since microcontroller block architectures and performance can vary, the typical non-limiting range of time required to generate the recovered electrical signal is in the range of 20 ms to 200 ms.

A benefit of embodiments of the present invention is that the LSS method for determining phase requires only a relatively small amount of computation time, and can, therefore, be performed using a low-power microcontroller. Traditional methods that do not rely on the initial estimation of frequency, phase and offset typically require many hours to run and require powerful power-consuming stand-alone computers that cannot be integrated into a hand-held test meter. Moreover, the techniques employed in embodiments of the present invention have been shown to be robust in that they rarely encounter distorted signals that result in errors.

If desired to reduce computing time, an initial estimate of the phase of the recovered electrical signal can be made using arbitrary phases in 10 degree increments. Next, a final estimation of the phase can be performed using 0.5° increments from a phase starting 5° before the initial phase estimate. This requires, therefore, a maximum of 18 LSS calculations (i.e., 7 for initial estimation and 11 for final estimation).

Once apprised of the present disclosure, one skilled in the art will recognize that any or all of the electrical signal receiver block, signal recovery block, and microcontroller block and memory block can be integrated into a combined block. For example, the electrical signal receiver block, signal recovery block, and microcontroller block can be combined into a single block configured to perform all of the functions performed by the individual blocks.

FIG. 8 is a flow diagram depicting stages in a method 800 for recovering an electrical signal employed in a hand-held test meter. Method 800 includes receiving, by an electrical signal receiving block of the hand-held test meter, an electrical signal from an analytical test strip inserted in the hand-held test meter that has been distorted into a distorted electrical signal (see step 810 of FIG. 8). The distorted electrical signal received by the electrical receiving block can be, for example, a sine wave electrical signal that has been distorted due to the hand-held test meter being in an electrically noisy environment. Such electrically noisy environments include, for example, environments wherein the hand-held test meter is in a relatively strong electrical field due to close proximity to a mobile phone transmitting a GSM signal.

Subsequently, at step 820 of method 800, the electrical signal is recovered from the distorted electrical signal by employing a signal recovery block and a microcontroller block of the hand-held test meter to generate a recovered electrical signal based on (i) a predetermined recovered electrical signal frequency; (ii) a recovered electrical signal amplitude estimated from the distorted signal; (iii) a recovered electrical signal offset calculated as the mean offset of the distorted electrical signal; and (iv) a recovered electrical signal phase determined using a least squares calculation methodology.

Once apprised of the present disclosure, one skilled in the art will recognize that method 800 can be readily modified to incorporate any of the techniques, benefits and characteristics of hand-held test meters according to embodiments of the present invention and described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. A hand-held test meter for use with an analytical test strip in the determination of an analyte in a bodily fluid sample, the hand-held test meter comprising:
a housing;
an electrical signal receiving block disposed in the housing;
a signal recovery block disposed in the housing; and
a microcontroller block disposed in the housing;
wherein the electrical signal receiving block is configured to receive an electrical signal from an analytical test strip inserted in the hand-held test meter that has been distorted into a distorted electrical signal; and
wherein the signal recovery block and microcontroller block are configured to recover the electrical signal from the distorted electrical signal by generating a recovered electrical signal based on a predetermined recovered electrical signal frequency, a recovered electrical signal amplitude estimated from the distorted signal, a recovered electrical signal offset estimated from the distorted electrical signal and a recovered electrical signal phase determined using a least sum squares calculation.

2. The hand-held test meter of claim 1 wherein the electrical signal and the recovered electrical signal are sine waves.

3. The hand-held test meter of claim 1 wherein the predetermined recovered electrical frequency is identical to an excitation frequency used to create the electrical signal.

4. The hand-held test meter of claim 1 wherein the recovered electrical signal amplitude is estimated as a root-mean-square of distorted signal amplitudes.

5. The hand-held test meter of claim 1 wherein the recovered electrical signal offset is estimated as a mean of the distorted signal offsets.

6. The hand-held test meter of claim 1 wherein the recovered electrical signal phase is estimated using a least sum square (LSS) technique.

7. The hand-held test meter of claim 6 wherein the LSS technique first determines an initial estimate of the recovered electrical signal phase using arbitrary phases in 10 degree increments followed by a final estimate of the recovered electrical signal phase using arbitrary phases in 0.5 degree increments.

8. The hand-held test meter of claim 6 wherein the LSS technique employs a maximum of 18 recovered electrical signal phase estimates to estimate the recovered electrical signal phase.

9. The hand-held test meter of claim 1 wherein the electrical signal is an ac current signal generated during a capacitance measurement on the analytical test strip.

10. The hand-held test meter of claim 1 wherein the hand-held test meter is configured for the determination of glucose in a whole blood sample using an electrochemical-based analytical test strip.

11. A method for recovering an electrical signal employed in a hand-held test meter, the method comprising:
receiving, by an electrical signal receiving block of the hand-held test meter, an electrical signal from an analytical test strip inserted in the hand-held test meter that has been distorted into a distorted electrical signal;
recovering the electrical signal from the distorted electrical signal by employing a signal recovery block and a microcontroller block of the hand-held test meter to generate a recovered electrical signal based on a predetermined recovered electrical signal frequency, a recovered electrical signal amplitude estimated from the distorted signal, a mean offset of the distorted electrical signal and a recovered electrical signal phase determined using a least squares calculation.

12. The method of claim 11 wherein the electrical signal and the recovered electrical signal are sine waves.

13. The method of claim 11 wherein the predetermined recovered electrical frequency is identical to an excitation frequency used to create the electrical signal.

14. The method of claim 11 wherein the recovered electrical signal amplitude is estimated as a root-mean-square of distorted signal amplitudes.

15. The method of claim 11 wherein the recovered electrical signal offset is estimated as a mean of the distorted signal offsets.

16. The method of claim 11 wherein the recovered electrical signal phase is estimated using a least sum square (LSS) technique.

17. The method of claim 16 wherein the LSS technique first determines an initial estimate of the recovered electrical signal phase using arbitrary phases in 10 degree increments followed by a final estimate of the recovered electrical signal phase using arbitrary phases in 0.5 degree increments.

18. The method of claim 17 wherein the LSS technique employs a maximum of 18 recovered electrical signal phase estimates to estimate the recovered electrical signal phase.

19. The method of claim 11 wherein the electrical signal is an ac current signal generated during a capacitance measurement on the analytical test strip.

20. The method of claim 11 wherein the hand-held test meter is configured for the determination of glucose in a whole blood sample using an electrochemical-based analytical test strip.

21. The method of claim 11 wherein the recovering step occurs in a time duration range from 20 ms to 200 ms.
